(19) United States
(12) Patent Application Publication
(10) Pub. No.: US 2003/0181596 A1
(43) Pub. Date: Sep. 25, 2003

(54) Composite polymer/polymer material with high content in amorphous dispersed phase and preparation method

(76) Inventors: Philippe Cassagnau, Millery (FR); Alain Michel, Lyon (FR)

Correspondence Address: YOUNG & THOMPSON, 745 SOUTH 23RD STREET 2ND FLOOR, ARLINGTON, VA, 22202

(21) Appl. No.: 10/240,933

(22) PCT Filed: Apr. 6, 2001
(86) PCT No.: PCT/FR01/01057

(30) Foreign Application Priority Data
Apr. 6, 2000 (FR) 00/04420

(51) Int. Cl. C08L 23/00

(52) U.S. Cl. 525/240; 264/40.6; 264/211.23

(57) ABSTRACT

The invention concerns a micro-composite polymer/polymer material comprising an amorphous polymer (I) forming a dispersed phase localised inside a thermoplastic or elastomeric polymer (II) forming a matrix, the glass transition temperature of polymer (I) forming a dispersed phase being higher by at least 20° C. than the melting or softening point of matrix-forming polymer (II), and the amorphous polymer content (I) forming the dispersed phase being not less than 40 wt. %. The invention also concerns a method for obtaining said material comprising steps which consist in: extruding, at regulated temperature, said melted polymer mixture, said regulating temperature being decreasing from the feeding zone (A) to the die zone (F) of said extruding machine (1) so that the material temperature in said die zone (F) is lower than the temperature of recrystallisation or solidification of polymer (II), and higher than the melting or softening point of amorphous polymer (I); and cooling at room temperature the resulting micro-composite material.

The present invention relates to a process for producing polymer/polymer microcomposite materials by controlled-temperature extrusion and to the resulting microcomposite materials.

The expression “polymer/polymer microcomposite material” denotes a material comprising a blend of immiscible polymers, one of which forms a phase dispersed in the other, which constitutes the matrix.

Polymer/polymer microcomposite materials are generally prepared by extrusion at a constant temperature or at a temperature which increases substantially from the feed zone to the die, this extrusion step being followed by a drawing step and a quench on leaving the die, before being reprocessed for the intended applications.

In the case of a dispersed phase of the amorphous polymer type, dispersed-phase contents of less than 20% (by weight) are currently the limit. Above this, the morphology and the reproducibility of the final material obtained cannot be controlled.

In general, the thermomechanical properties of currently available microcomposite materials are limited and insufficient for their subsequent processing.

One of the objectives of the present invention is to provide polymer/polymer microcomposite materials highly filled with reinforcing polymer of the amorphous polymer type, which has a defined morphology and is stable and reproducible.

Another objective of the invention is to provide a process for producing the aforementioned microcomposite materials that can be processed in a simple and reproducible manner with high contents of the dispersed phase.

Another objective of the invention is to provide such a process for producing microcomposite materials as indicated above, allowing materials with improved thermomechanical properties to be obtained.

Another objective of the present invention is also to provide polymer/polymer microcomposite materials that can be used as starting materials in processes for producing shaped articles, without their thermomechanical properties being affected.

More specifically, according to a first aspect, the subject of the invention is a polymer/polymer microcomposite material comprising an amorphous polymer (I) forming a dispersed phased localized within a matrix-forming elastomer or thermoplastic polymer (II), the glass transition temperature of the dispersed-phase-forming polymer (I) being at least 20° C. above the melting point or softening temperature of the matrix-forming polymer (II) and the content of the dispersed-phase-forming amorphous polymer (I) being greater than or equal to 40% by weight.

The subject of the invention is also a process for producing such composite materials, characterized in that it comprises the steps consisting in:

introducing, at a controlled temperature into the feed zone (F) of an extruder (1), a blend (2) comprising said polymers (I) and (II), the control temperature in this zone being above the melting point or softening temperature of each of the polymers of said blend (2);

extruding said polymer blend in the melt state at a controlled temperature, said control temperature decreasing from the feed zone (F) to the die zone (D) of said extruder (1) so that the material temperature in said die zone (D) is below the recrystallization or solidification temperature of the polymer (II) and above the melting point or softening temperature of the amorphous polymer (I); and

cooling the resulting microcomposite material to room temperature.

The invention also relates to a process for obtaining shaped articles, using, as starting material, a microcomposite material as mentioned above, at a controlled temperature, such that, throughout the formation of the shaped article, the material temperature remains below the melting point or softening temperature of the polymer forming the dispersed phase of the microcomposite material used.

The inventors have demonstrated that, by processing a blend of chosen polymers (or copolymers) by a dynamic quench process as defined below, it is possible to obtain, in a reproducible and stable manner, microcomposite materials with a high content of amorphous dispersed phase, having improved thermomechanical properties.

The invention will be described in greater detail below with reference to the drawings in which:

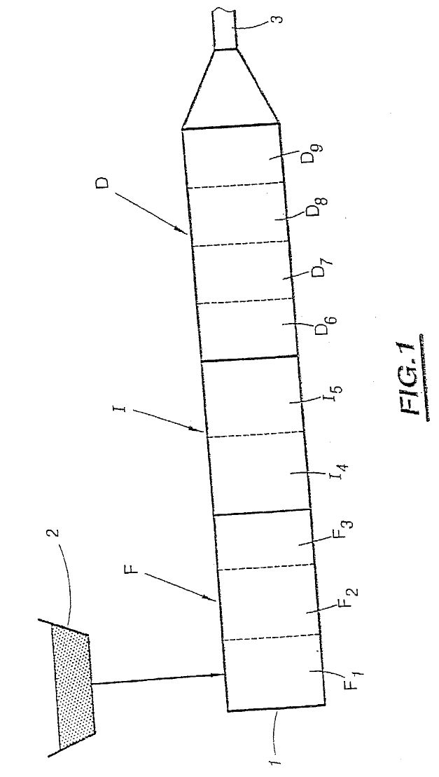

FIG. 1 shows diagrammatically the extrusion step of the process according to the invention;

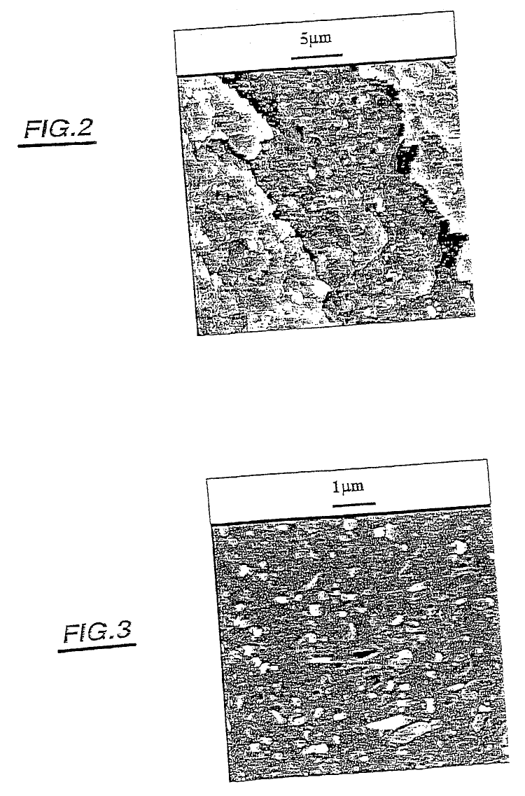

FIGS. 2 and 3 are photographs taken in a scanning electron microscope showing the morphology of materials obtained from a 50/50 ethylene-vinyl acetate (EVA)/polycarbonate (PC) blend by a conventional process and by the dynamic quench process according to the invention, respectively; and

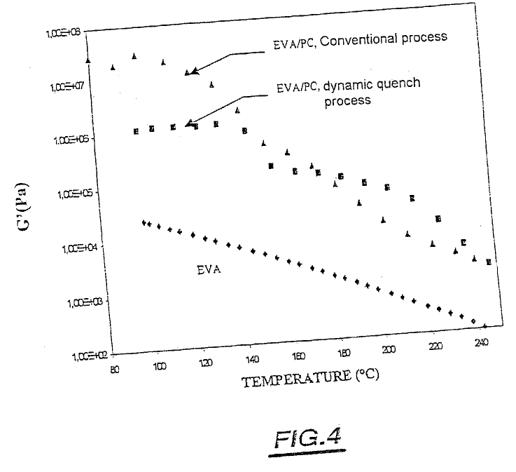

FIG. 4 is a comparative diagram showing the thermodynamic behavior of the materials of FIGS. 2 and 3 obtained according to a conventional process (▴) and according to the dynamic quench process of the invention (▪) respectively, and of the EVA alone (♦) at a stressing frequency ω of 1 rad/sec.

In general, in the process of the invention, a polymer blend comprising at least the polymer (I), intended to form the dispersed phase (called “dispersed-phase-forming polymer (I)”) and the polymer (II) intended to form the matrix (called “matrix-forming polymer (II)”) is firstly produced.

Within the context of the invention, the term “polymer” denotes, without distinction, one or more polymers and/or copolymers.

The polymers (I) and (II) are specifically immiscible polymers, that is to say, within the context of the invention, polymers that are immiscible in the melt state under the conditions for processing them in order to produce the desired materials, and in the final extruded material.

In general, the choice of polymers used in the invention is made in such a way that the crystallization or solidification temperature of the polymer (I) intended to form the dispersed phase is substantially greater than the melting point or softening temperature of the polymer (II) intended to form the matrix. The expression “substantially greater temperature” is understood to mean a difference of at least 20° C. between the temperatures in question and preferably a difference ranging from 30° C. to 50° C. A difference of about 30° C. (that is to say advantageously between 25 and 40° C., and typically between 28 and 35° C.) is more particularly preferred.

The polymer (II) may be chosen from semicrystalline or amorphous thermoplastic polymers or else from elastomers.

Among the examples of polymers suitable as the matrix-forming polymer (II), mention may be made of vinyl acetate and acrylic ester polymers or copolymers, more particularly of ethylene/vinyl acetate or ethylene/acrylic ester polymers or copolymers. Typically, the polymer (II) is an ethylene/vinyl acetate polymer (EVA).

As regards the polymer (I), this is specifically chosen from amorphous polymers.

Among amorphous polymers suitable for the purposes of the invention, mention may be made of polycarbonates, polystyrenes and acrylic and methacrylic polyesters, or blends thereof. Typically, the dispersed-phase-forming polymer (I) is a polycarbonate.

The process of the invention is carried out in an extruder. It is within the competence of a person skilled in the art to choose the characteristics of the extruder to be employed, especially so as to obtain relatively rapidly, by melt blending, a homogeneous blend of the polymers, taking into account the physico-chemical characteristics of the extruded material.

The extruder used is preferably a twin-screw extruder, the length/diameter ratio of which is advantageously greater than or equal to 34.

The speed of rotation of the screws and the polymer feed rate may be adapted by a person skilled in the art so as to limit any self-heating and to meet the abovementioned temperature condition.

FIG. 1 shows the barrel of an extruder 1 indicating, diagrammatically, in succession the feed zone F, an intermediate zone I and the die zone D which are subjected respectively to defined control temperatures as explained below. A die 3 is furthermore placed at the exit of the extruder.

The polymer blend 2 is introduced into the feed zone F of the extruder 1. The control temperature T_{feed} is above the melting point or softening temperature of each of the polymers of said blend. The polymers are then rapidly melt-blended so that the polymer forming the minority phase is dispersed homogeneously in the other polymer.

It will be recalled that, in general, the control temperature corresponds to the temperature (set temperature) applied to the barrel of the extruder and takes into account, in particular, the thermal phenomena that may occur in the installation and the self-heating of the processed material which may occur during the extrusion operation. The choice of the control temperature depends on the polymers used.

The extrusion operation is continued on the polymer blend in the melt state as far as the die zone D, where it will undergo a “dynamic quench”.

The expression “dynamic quench” denotes a controlled cooling operation carried out in the extruder, upstream of the die, which causes the dispersed-phase-forming polymer to recrystallize or solidify in the matrix-forming polymer, under the shear forces and the mechanical stresses imposed by the extruder (rotation of the screws). A polymer/polymer microcomposite material with a specific and controlled morphology, having improved thermomechanical properties as explained below, is thus obtained.

For this purpose, the control temperature T_{die} in the die zone D is set so that the temperature of the material lying within this zone is below the recrystallization or solidification temperature of the dispersed-phase-forming polymer (I).

The control temperature T_{die} is advantageously at least 20° C. below the recrystallization or solidification temperature of the dispersed-phase-forming polymer (I) and is preferably 30° C. to 50° C. below this temperature.

In other words, the temperature in the die zone D is substantially below the temperature of the feed zone F and it follows a decreasing profile between said zones, passing through an intermediate zone I where the temperature Tᵢ is below that of the zone F but does not yet correspond to the “dynamic quench” temperature.

On exiting the die 3, the material is simply cooled to room temperature.

By carrying out the process of the invention, a material is obtained which has a controllable and reproducible morphology and is highly filled with reinforcing polymer without this high content of polymer (I) diminishing the cohesion properties of the material.

According to the invention, the content of dispersed-phase-forming polymer (I) is specifically greater than 40% by weight (i.e. greater than 35% by volume) with respect to all of the polymers. In particular, so as not to obtain excessively brittle materials, it is preferred in general that this content of polymer (I) be less than 60% by weight and advantageously less than 50% by weight. Thus, the content of polymer (I) may typically be between 40 and 45% by weight.

In the material obtained after carrying out the process of the invention, the amorphous polymer (I) is present in a finely dispersed form and the dispersed amorphous phase is generally in the form of rods dispersed in the matrix. The size of these rods is generally of the order of 1 μm. Whatever the precise morphology of the dispersed phase, the average size of the globules of polymer (I) dispersed within the matrix of polymer (II) is generally of the order of one micron.

A typical example of the morphology obtained using the “dynamic quench” process of the invention is given in FIG. 3.

As a comparison, FIG. 2 shows that phase continuity is obtained by a conventional process in which the quench operation is carried out, independently, after extrusion. In this case, a defined, stable and reproducible morphology cannot be obtained, especially because of the fact that this morphology depends considerably on the processing conditions of the process.

The composite materials obtained in accordance with the present invention retain their morphology and consequently their properties at temperatures below the melting point or softening temperature of the polymer (I) forming their dispersed phase.

The materials obtained according to the process of the invention therefore constitute useful intermediate products which can serve as starting materials for the manufacture of shaped articles. In this context, they may be processed using various techniques chosen according to the shaped article that it is desired to obtain. The processes for producing shaped articles using the microcomposite materials of the invention as starting materials may thus consist, for example, of one or more extrusion, injection-molding and/or compression-molding operations.

Whatever the treatment applied during formation of the shaped articles, the processing temperature of the microcomposite materials according to the invention (that is to say the material temperature) must specifically remain below the melting point or softening temperature of the polymer (I) forming the dispersed phase. In the general case, this material temperature is preferably at least 20° C. below, and more preferably 30° C. to 50° C. below, the melting point or softening temperature of the polymer (I) forming the dispersed phase.

The processes for producing shaped articles using the microcomposite materials described above, under the abovementioned controlled temperature conditions, constitute one particular subject of the invention.

The features and advantages of the invention will be explained in greater detail in the light of the examples presented below.

### EXAMPLES

### Equipment and Method

To produce the examples described below, a twin-screw extruder with corotating and interpenetrating screws was used. All the screw components had two flights. The diameter of the screws was 34 mm and the distance between the axes was 30 mm. The length/diameter (L/D) ratio of the extruder was L/D=34.

The barrel had nine successive and independent parts for controlling the temperature, defining three zones—the feed zone F, the intermediate zone I and the die zone D shown diagrammatically in FIG. 1.

These heating zones were also equipped with a pressurized-water circuit, controlled by a solenoid valve, for removing the heat produced by viscous dissipation of the polymers introduced by the mechanical sheer of the screws. This system allowed the self-heating phenomena to be considerably limited.

The various heating zones of the barrel are illustrated in FIG. 1.

The die consists of a flat die of the coat-hanger type, having the following dimensions: width L=50 mm, length l=30 mm and thickness h=2 mm. The die was also controlled independently of the other zones, but did not have a water control system.

For the entire process described, the speed of rotation of the screws was set at 160 rpm and the total feed rate of the extruder was 3 kg/h. The two polymers (the matrix-forming polymer and the dispersed-phase-forming polymer) were introduced together into the feed zone F of the extruder.

The material temperature of the polymer was controlled by two infrared (IR) temperature sensors. These sensors allow the actual temperature of the molten polymers to be measured and controlled. They were placed in the intermediate zone I₄ and at the head of the die 3. A pressure sensor allowed the pressure at the entry of the die 3 to be measured and controlled.

Tensile tests were carried out on specimens cut using a blanking die on the extruded sheets. The values given for each specimen are the average of ten tests. The test pieces were of the H3 type according to the NF T51-034 Standard.

The test conditions were the following:

apparatus: INSTRON 1175 with self-clamping pneumatic jaws (1 kN load cell);

temperature: room temperature (23° C.);

test speed: 50 mm/min.

In terms of linear viscoelasticity, the flow threshold stress was measured at 120° C. The usage temperature range of the material is defined as being the range in which the material does not creep for applied stresses below the critical stress Gp (flow threshold). The usage temperature, defined according to this threshold stress criterion, must therefore be below the melting point or softening temperature of the dispersed phase.

### Example 1

EVA/PC Composite

The matrix consisted of an ethylene-vinyl acetate copolymer containing 28% vinyl acetate by weight. This is an Atochem copolymer with the commercial reference EVATANE 2803. Its melting point is 80° C. and its crystallization temperature about 50° C.

The dispersed phase consisted of polycarbonate (PC), a Bayer product with the commercial reference MAKROLON 2658.

50% by weight of polycarbonate were dispersed in the EVA matrix using the process of the invention.

The temperature setpoints of the various temperature control zones are given in Table 1.

TABLE 1

| | F | | | I | | D | | | | |
|---|---|---|---|---|---|---|---|---|---|---|
| Zones | 1 | 2 | 3 | 4 | 5 | 6 | 7 | 8 | 9 | die |
| T (° C.) | 250 | 250 | 250 | 200 | 170 | 110 | 110 | 110 | 110 | 110 |

The material temperatures indicated by the infrared sensors and the pressure measured in the die head are given in Table 2.

TABLE 2

| Sensors | T_{IR} (screws) | T_{IR} (die) | Pressure |
|---|---|---|---|
| Measurements | 240° C. | 130° C. | 50 bar |

A fine dispersion of the PC phase was obtained by the process of the invention and thus allowed a high PC concentration to be obtained while maintaining the cohesion properties of the material for usage temperatures below the glass transition temperature of the polycarbonate.

### Example 2 (Comparative Example)

A co-continuous morphology of the two phases as shown in FIG. 2 was obtained by a conventional processing method.

This morphology was not stable and depended considerably on the processing conditions.

The measured thermomechanical properties are compared in Table 18 with the control specimens obtained by a conventional processing method on the same extruder (identical rate and identical screw speed).

TABLE 3

| | | | Tensile | Elongation | |
|---|---|---|---|---|---|
| | Threshold | | Strength | at break | Young's |
| | stress at | Usage | at 23° C. | at 23° C. | Modulus |
| Specimens | 120° C. | Temperature | (Mpa) | (%) | (MPa) |
| Control | / | <80° C. | 5 | 20 | 300 |
| Invention | 7 × 10⁵Pa | <150° C. | 8 | 160 | 120 |

FIG. 4 shows the thermomechanical behavior of the two types of material, measured by the variation in the elastic modulus as a function of temperature for a stressing frequency ω of 1 rad/s.

1. A polymer/polymer microcomposite material comprising an amorphous polymer (I) forming a dispersed phased localized within a matrix-forming elastomer or thermoplastic polymer (II), the glass transition temperature of the dispersed-phase-forming polymer (I) being at least 20° C. above the melting point or softening temperature of the matrix-forming polymer (II) and the content of the dispersed-phase-forming amorphous polymer (I) being greater than or equal to 40% by weight.

2. The material as claimed in claim 1, characterized in that the dispersed-phase-forming amorphous polymer (I) is chosen from polycarbonates, polystyrenes, acrylic or methacrylic polyesters or blends of these compounds.

3. The material as claimed in claim 1 or claim 2, characterized in that the dispersed-phase-forming amorphous polymer (I) is a polycarbonate.

4. The material as claimed in any one of claims 1 to 3, characterized in that the dispersed phase is in the form of rods.

5. The material as claimed in any one of claims 1 to 4, characterized in that the average size of the globules of polymers (I) dispersed in the matrix of polymer (II) is of the order of one micron.

6. The material as claimed in any one of claims 1 to 5, characterized in that the glass transition temperature of the dispersed-phase-forming amorphous polymer (I) is 30° C. to 50° C. above the melting point or softening temperature of the matrix-forming polymer (II).

7. The material as claimed in claim 6, characterized in that the glass transition temperature of the dispersed-phase-forming amorphous polymer (I) is 30° C. above the melting point or softening temperature of the matrix-forming polymer (II).

8. The material as claimed in any one of the preceding claims, characterized in that the matrix-forming polymer (II) is chosen from vinyl acetate and acrylic ester polymers or copolymers.

9. The material as claimed in claim 8, characterized in that the matrix-forming polymer (II) is chosen from ethylene/vinyl acetate or ethylene/acrylic ester polymers or copolymers.

10. The material as claimed in claim 9, characterized in that the matrix-forming polymer (II) is ethylene-vinyl acetate (EVA).

11. A process for producing a polymer/polymer microcomposite material as claimed in any one of claims 1 to 10, characterized in that it comprises the steps consisting in:
introducing, at a controlled temperature into the feed zone (F) of an extruder (1), a blend (2) comprising said polymers (I) and (II), the control temperature in this zone being above the melting point or softening temperature of each of the polymers of said blend (2);
extruding said polymer blend in the melt state at a controlled temperature, said control temperature decreasing from the feed zone (F) to the die zone (D) of said extruder (1) so that the material temperature in said die zone (D) is below the recrystallization or solidification temperature of the polymer (II) and above the melting point or softening temperature of the amorphous polymer (I); and
cooling the resulting microcomposite material to room temperature.

12. The process as claimed in claim 11, characterized in that the control temperature in the die zone (D) is at least 20° C. below the recrystallization or solidification temperature of the polymer (II).

13. The process as claimed in claim 12, characterized in that the control temperature in the die zone (D) is 30° C. to 50° C. below the recrystallization or solidification temperature of the polymer (II).

14. The process as claimed in any one of claims 11 to 13, characterized in that the polymer blend is extruded in the melt state in a twin-screw extruder.

15. The process as claimed in claim 14, characterized in that the extruder has a length/diameter (L/D) ratio of greater than or equal to 34.

16. A process for producing a shaped article, using as starting material a microcomposite material as claimed in any one of claims 1 to 10, or a microcomposite material obtained from a process as claimed in any one of claims 11 to 15, the temperature being controlled during formation of said shaped article in such a way that the material temperature remains below the melting point or softening temperature of the polymer (I) forming the dispersed phase of said microcomposite material.

17. The process as claimed in claim 16, characterized in that the material temperature remains at least 20° C. below the melting point or softening temperature of the polymer (I) forming the dispersed phase of the microcomposite material.
